(19) United States
(12) Patent Application Publication
(10) Pub. No.: US 2023/0090908 A1
(43) Pub. Date: Mar. 23, 2023

(54) PAINT SPRAY NOZZLE FOR A PAINT SPRAY SYSTEM

(71) Applicant: GM Global Technology Operations LLC, Detroit, MI (US)

(72) Inventor: Joseph E. Bickley, Swartz Creek, MI (US)

(21) Appl. No.: 17/483,116

(22) Filed: Sep. 23, 2021

(51) Int. Cl. B05B 1/06; B05B 15/55

(52) U.S. Cl. CPC B05B 1/06; B05B 15/55

(57) ABSTRACT

A paint spray nozzle is provided for a paint spray system. The nozzle includes a single-piece body having a conduit portion. The conduit portion includes a first surface defining a first passage that terminates at an orifice along a longitudinal axis and a second surface that defines a second passage along the longitudinal axis. The second passage is fluidly connected to the orifice. The orifice is configured to direct the paint to flow along a flow path through the second passage. The second surface defines an inlet cross-sectional width positioned at the orifice and an outlet cross-sectional width positioned at an outlet. The outlet cross-sectional width is larger than the inlet cross-sectional width, such that the paint that deposits on the second surface is positioned relative to the longitudinal axis to be re-absorbed into the flow path of the paint.

### INTRODUCTION

The present disclosure relates to paint spray systems for atomizing paint onto motor vehicles, and more particularly to a paint spray systems having a paint spray nozzle with a passage that reduces deposits of paint on the nozzle, increases first-time paint quality, increases throughput through a paint booth, and improves the efficiency of cleaning the nozzle.

Modern paint spray systems can include a reservoir of paint, an applicator device fluidly connected to the reservoir, a nozzle for directing paint from the applicator device to a vehicle surface, a pressure source for moving paint from the reservoir through the applicator device and nozzle, and a power source for actuating the pressure source. The nozzle typically includes an inlet fluidly connected to the reservoir via one or more lines to receive a flow of paint. The nozzle further includes a surface that defines a channel extending along an axis from the inlet to an outlet. The outlet is defined by a flat tip or rim surface positioned perpendicular to the channel, and the passage typically has a constant diameter from the inlet to the outlet. The viscosity and intermolecular forces of the paint can cause a portion of the paint flowing along the surface of the conduit portion to exit the passage and form a globular deposit on the rim surface. The globular deposit of one color of paint can mix with paints of other color and create a quality defect of comingled colors on otherwise smooth painted surface. Dried or semi-dried portions of paint on the rim surface can adversely restrict or redirect the flow of paint applied to the vehicle and/or later become dislodged during the paint process and deposit on the painted surface. These defects can reduce the first time quality and ultimately affect the throughput of a production plant.

Thus, while existing paint spray systems can achieve their intended purpose, there is a need for a new and improved paint spray system that addresses these issues.

### SUMMARY

According to several aspects of the present disclosure, a paint spray nozzle for a paint spray system includes a single-piece body having a conduit portion that includes a first surface defining a first passage, which terminates at an orifice along a longitudinal axis. The single-piece body further includes a second surface defining a second passage along the longitudinal axis, with the second passage fluidly connected to the orifice. The orifice is configured to direct the paint to flow along a flow path through the second passage. The second surface defines an inlet cross-sectional width positioned at the orifice and an outlet cross-sectional width positioned at an outlet, with the inlet and the outlet being spaced from one another along the longitudinal axis. The outlet cross-sectional width is larger than the inlet cross-sectional width, such that the paint that deposits on the second surface is positioned relative to the longitudinal axis to be re-absorbed into the flow path of the paint.

In one aspect, the conduit portion terminates along the longitudinal axis at the outlet.

In another aspect, the single-piece body further includes a shroud spaced radially outward from the conduit portion to define a gap therebetween, with the shroud being disposed about the longitudinal axis for surrounding the conduit portion.

In another aspect, the second surface includes a frustoconical surface to define an inner diameter that linearly increases from the inlet cross-sectional width to the outlet cross-sectional width.

In another aspect, the first passage includes first and second ends along the longitudinal axis with the second end positioned downstream of the first end, and the conduit portion includes a cylindrical surface having a constant inner diameter along the longitudinal axis from the first end to the second end.

In another aspect, the frustoconical surface and the cylindrical surface are positioned coaxially relative to one another.

In another aspect, the frustoconical surface is disposed 60 degrees relative to the frustoconical surface.

In another aspect, the first and second surfaces face the longitudinal axis.

According to several aspects of the present disclosure, a paint spray system includes a reservoir of paint and a paint spray nozzle having a single-piece body. The single-piece body includes a conduit portion having a first surface, which defines a first passage that terminates at an orifice along a longitudinal axis. The single-piece body further includes a second surface, which defines a second passage along the longitudinal axis, with the second passage fluidly connected to the orifice and the orifice being configured to direct the paint to flow along a flow path through the second passage. The second surface defines an inlet cross-sectional width positioned at the orifice and an outlet cross-sectional width positioned at an outlet, with the inlet and the outlet being spaced from one another along the longitudinal axis. The outlet cross-sectional width is larger than the inlet cross-sectional width, such that the paint that deposits on the second surface is positioned relative to the longitudinal axis to be re-absorbed into the flow path of the paint. At least a portion of the second surface comprises a paint repellant material. The paint spray system further includes a pump for pumping paint from the reservoir to the paint spray nozzle.

In one aspect, the paint repellant material is a hydrophobic material or a hydrophilic material.

In another aspect, the paint repellant material is a coating bonded to the second surface.

In another aspect, the coating includes at least one of a polyurethane, a nano-particle, and a fluorinated hydrocarbon.

In another aspect, the second surface includes an inlet surface portion adjacent to the orifice and an outlet surface portion adjacent to the outlet, and the coating covers an entirety of the inlet surface portion.

In another aspect, the outlet surface portion is free of the coating.

In another aspect, the second surface includes a plurality of capillary grooves spaced radially from one another about the longitudinal axis for drawing paint toward the orifice and a flow of paint therethrough.

In another aspect, the conduit portion terminates along the longitudinal axis at the outlet.

In another aspect, the single-piece body further includes a shroud spaced radially outward from the conduit portion to define a gap therebetween, with the shroud being disposed about the longitudinal axis for surrounding the conduit portion.

In another aspect, the second surface includes a frustoconical surface that defines an inner diameter that linearly increases from the inlet cross-sectional width to the outlet cross-sectional width.

According to several aspects of the present disclosure, a method is provided for operating a paint spray nozzle. The paint spray nozzle includes a single-piece body having a conduit portion. The conduit portion includes a first surface defining a first passage, which terminates at an orifice along a longitudinal axis. The conduit portion further includes a second surface that defines a second passage along the longitudinal axis. The second passage is fluidly connected to the orifice, and the second surface defines an inlet cross-sectional width positioned at the orifice and an outlet cross-sectional width positioned at an outlet. The inlet and the outlet are spaced from one another along the longitudinal axis. The outlet cross-sectional width is larger than the inlet cross-sectional width. The method includes the orifice directing the paint to flow along a flow path through the second passage, and the second surface positions paint deposited on the second surface relative to the longitudinal axis, such that the paint is re-absorbed into the flow path of the paint.

In one aspect, the orifice directs a cleaning solvent to flow along the flow path through the second passage, and the second surface positions paint deposited on the second surface relative to the longitudinal axis such that the cleaning solvent removes paint from the second surface.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic representation of one example of a paint spray system having a paint spray nozzle for applying a coat of paint to a motor vehicle.

FIG. 2 is an enlarged perspective view of the paint spray nozzle of FIG. 1, illustrating the nozzle being a single-piece body that has a conduit portion and a shroud.

FIG. 3 is a cross-sectional view of the conduit portion of FIG. 2.

FIG. 4 is a cross-sectional view of another example of the conduit portion of FIG. 2.

FIG. 5 is an end view of the conduit portion of FIG. 4.

FIG. 6 is a flow chart of one example of a method of operating the paint spray system of FIG. 1.

### DETAILED DESCRIPTION

The following description is merely exemplary in nature and is not intended to limit the present disclosure, application, or uses. Although the drawings represent examples, the drawings are not necessarily to scale and certain features may be exaggerated to better illustrate and explain a particular aspect of an illustrative example. Any one or more of these aspects can be used alone or in combination within one another. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

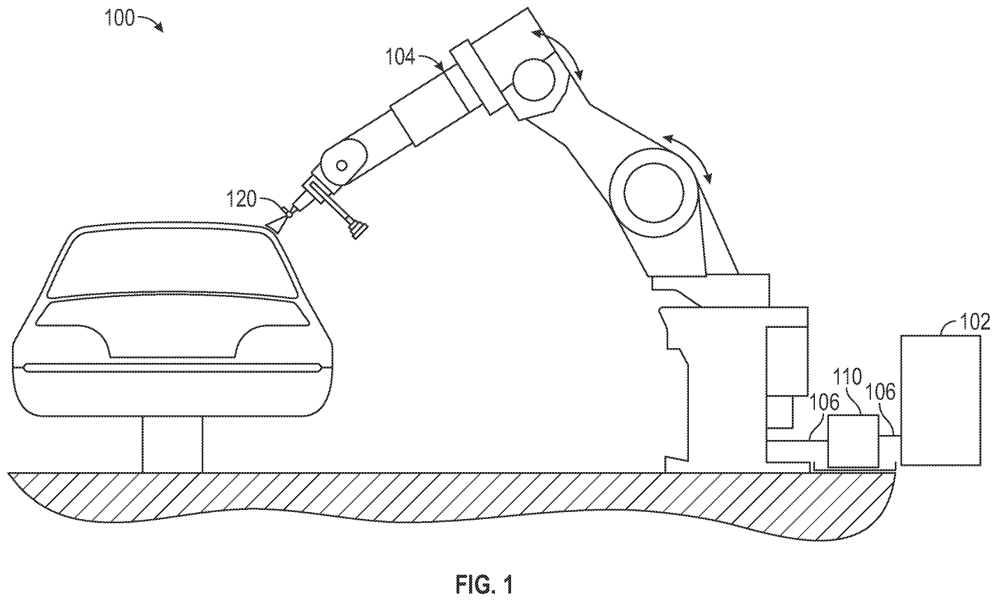

Referring to FIG. 1, one non-limiting example of a paint spray system 100 includes a reservoir 102 of paint and an applicator device 104 with one or more lines 106 receiving paint from the reservoir 102. Non-limiting examples of the applicator device 104 can include a gun, a wand, or an arm. The applicator device 104 can include a paint spray nozzle 120 (“nozzle”) fluidly connected to the lines for directing the flow of paint to a painted surface. As described in detail below, the nozzle 120 is configured to control a spray pattern, a droplet size, a spray angle, and intensity of the spray. The system 100 further includes a pressure source 108, such as a compressor or a pump, that moves paint from the reservoir 102 through the applicator device 104 and nozzle 120 to the painted surface. The system 100 further includes a power source 108 coupled to the pressure source 108 for actuating the pressure source 108 to move paint through the applicator device 104 and nozzle 120. The system 100 further includes a pump 110 for pumping paint from the reservoir 102 to the nozzle 120. While this non-limiting examples of the nozzle is a component of the paint spray system for applying a coat of paint to a component of a vehicle and cleaning the nozzle, it is contemplated that the nozzle can be a component of other systems flowing any suitable fluid.

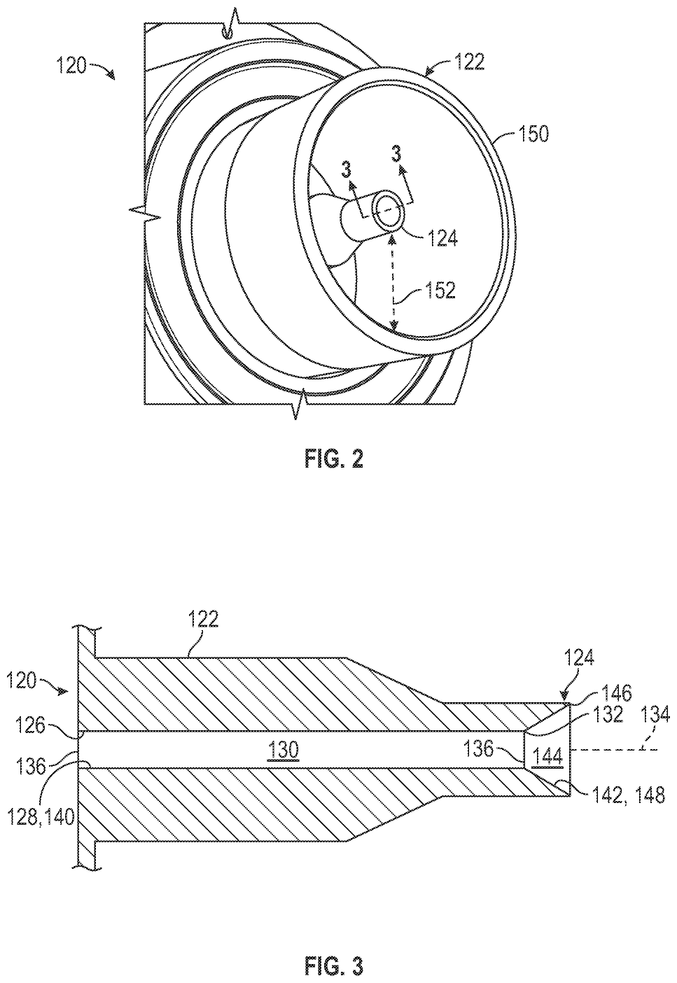

Referring to FIGS. 2 and 3, the nozzle 120 includes a single-piece body 122 that has a conduit portion 124. As shown in FIG. 3, the conduit portion 124 includes an inlet 126 fluidly connected to the reservoir 102 (FIG. 1) for receiving a flow of paint from the reservoir 102. The conduit portion 124 further includes a first surface 128 defining a first passage 130 that terminates at an orifice 132 along a longitudinal axis 134. The first surface 128 faces the longitudinal axis 134, and the first passage 130 includes first and second ends 136, 138 along the longitudinal axis 134 with the second end 138 positioned downstream of the first end 136. The conduit portion 124 includes a cylindrical surface 140 defining a constant inner diameter along the longitudinal axis 134 from the first end 136 to the second end 138.

The conduit portion 124 further includes a second surface 142 that faces the longitudinal axis 134 and defines a second passage 144 along the longitudinal axis 134, with the second passage 144 fluidly connected to the orifice 132. The orifice 132 is configured to direct the paint to flow along a flow path through the second passage 144. The second surface 142 defines an inlet cross-sectional width positioned at the orifice 132 and an outlet cross-sectional width positioned at an outlet 146, with the inlet 126 and the outlet 146 being spaced from one another along the longitudinal axis 134. The second surface 142 is a frustoconical surface 148 with an inner diameter that linearly increases from the inlet cross-sectional width to the outlet cross-sectional width. The outlet cross-sectional width is larger than the inlet cross-sectional width, such that the paint that deposits on the second surface 142 is positioned relative to the longitudinal axis 134 to be re-absorbed into the flow path of the paint. The frustoconical surface 148 is disposed 60 degrees relative to the frustoconical surface 148. The frustoconical surface 148 and the cylindrical surface 140 are positioned coaxially relative to one another. It is contemplated that other examples of the second surface can be angularly spaced relative to the cylindrical surface by more or less than 60 degrees.

As shown in FIG. 2, the single-piece body 122 further includes a shroud 150 spaced radially outward from the conduit portion 124 to define a gap 152 therebetween, with the shroud 150 being disposed about the longitudinal axis 134 for surrounding the conduit portion 124 to protect the conduit portion 124 and the flow of paint to the painted surface. The shroud 150 has an inner diameter that is coaxial with the cylindrical and frustoconical surfaces 140, 148 about the longitudinal axis 134. It is contemplated that other examples of the nozzle can include a shroud that is a separate component positioned adjacent to the conduit portion and/or attached to the conduit portion.

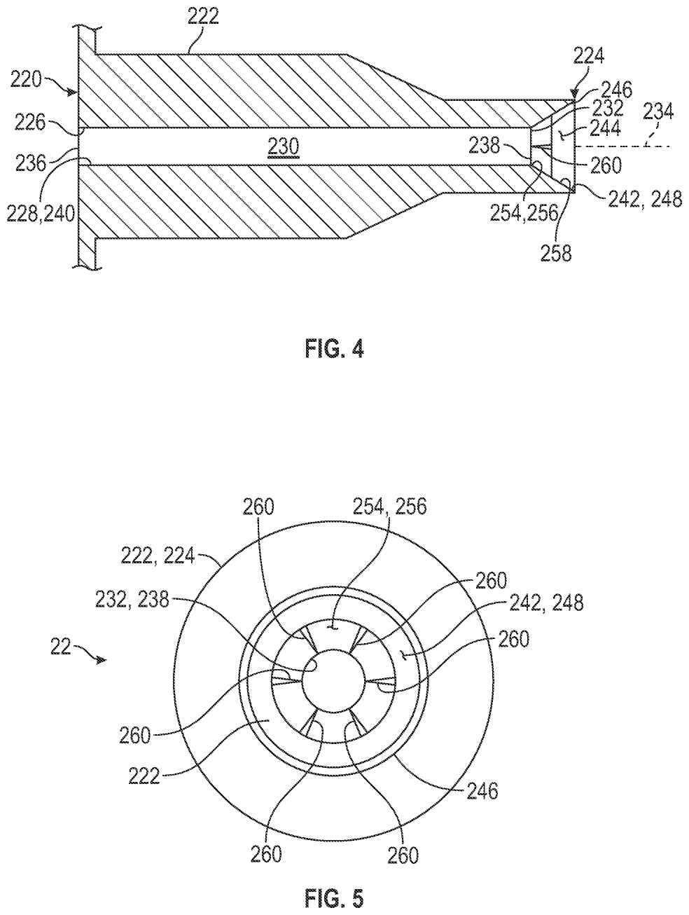

Referring to FIGS. 4 and 5, another non-limiting example of a paint spray nozzle 220 is similar to the paint spray nozzle 120 of FIG. 3 and includes similar components identified by the same numbers increased by 100. In this example, at least a portion of the second surface 242 includes a paint repellant material 254 that assists the flow of paint with re-absorbing paint deposited on the paint repellant material 254. More specifically, the second surface 242 includes an inlet surface portion 256 adjacent to the orifice 232 and an outlet surface portion 258 adjacent to the outlet 246, and the paint repellant material 254 is a coating bonded to the entire inlet surface portion 256 of the second surface and the outlet surface portion 258 is free of the coating. The coating can be a layer of hydrophobic material or a layer of hydrophilic material. Non-limiting examples of the coating include a polyurethane, a nano-particle, and a fluorinated hydrocarbon. It is contemplated that still other examples of the nozzle can include the paint repellant material coated onto any portion of the outlet surface portion and any portion of the inlet surface portion can be free of the paint repellant material.

Also, in this example, the inlet surface portion 256 of the second surface 242 includes a plurality of capillary grooves 260 spaced radially apart from one another about the longitudinal axis 234 for drawing, by capillary action, paint toward the orifice 132 where the flow of paint can re-absorb paint deposited on the second surface 242. Each groove can be linear and have a constant width along its length from the outlet surface portion 258 to the orifice 232. It is contemplated that other examples of the groove can be non-linear and/or have a width than decreases or increases from the outlet surface portion to the orifice.

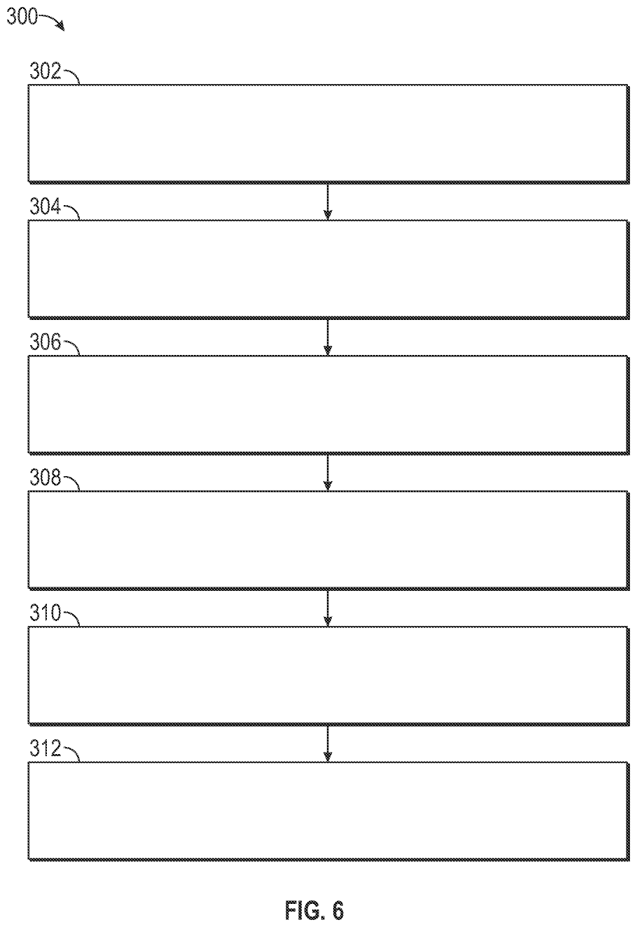

Referring to FIG. 6, a method 300 of operating the paint spray system 100 of FIG. 3 begins at block 302 with the power source 108 supplying power to the pressure source 108.

At block 304, the pressure source 108 moves paint from the reservoir 102 through the applicator device 104 and the nozzle 120, in response to the pressure source 108 receiving power from the power source 108.

At block 306, the first passage 130 and the orifice 132 of the nozzle 120 direct the paint to flow along a flow path through the second passage 144.

At block 308, the second surface 142 positions paint deposited onto the second surface 142 relative to the longitudinal axis 134, such that the paint is re-absorbed into the flow path of the paint. In this non-limiting example, the second surface 142 defines the second passage 144 along the longitudinal axis 134, with the second passage 144 fluidly connected to the orifice 132. The orifice 132 is configured to direct the paint to flow along a flow path through the second passage 144. The second surface 142 defines the inlet cross-sectional width positioned at the orifice 132 and the outlet cross-sectional width positioned at an outlet 146, with the inlet 126 and the outlet 146 being spaced from one another along the longitudinal axis 134. The second surface 142 is the frustoconical surface 148 with the inner diameter that linearly increases from the inlet cross-sectional width to the outlet cross-sectional width. The outlet cross-sectional width is larger than the inlet cross-sectional width, such that the paint that deposits on the second surface 142 is positioned relative to the longitudinal axis 134 to be re-absorbed into the flow path of the paint. The frustoconical surface 148 is disposed 60 degrees relative to the frustoconical surface 148, and the frustoconical surface 148 and the cylindrical surface 140 are positioned coaxially relative to one another.

At block 310, during a process for cleaning the conduit portion 124, the first passage 130 and the orifice 132 of the nozzle 120 directs a cleaning solvent to flow along the flow path through the second passage 144.

At block 312, similar to block 308 during a process for applying a coat of paint to a surface, e.g. a surface of a component of a vehicle, the second surface 142 of the nozzle 120 positions paint deposited on the second surface 142 relative to the longitudinal axis 134 such that the cleaning solvent removes any remaining paint on the second surface 142.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A paint spray nozzle for a paint spray system, the paint spray nozzle comprising:
a single-piece body having a conduit portion that includes:
a first surface defining a first passage that terminates at an orifice along a longitudinal axis; and
a second surface that defines a second passage along the longitudinal axis, with the second passage fluidly connected to the orifice;
wherein the orifice is configured to direct the paint to flow along a flow path through the second passage;
wherein the second surface defines an inlet cross-sectional width positioned at the orifice and an outlet cross-sectional width positioned at an outlet, with the inlet and the outlet being spaced from one another along the longitudinal axis, and the outlet cross-sectional width being larger than the inlet cross-sectional width, such that the paint that deposits on the second surface is positioned relative to the longitudinal axis to be re-absorbed into the flow path of the paint.

2. The paint spray nozzle of claim 1, wherein the conduit portion terminates along the longitudinal axis at the outlet.

3. The paint spray nozzle of claim 2, wherein the single-piece body further comprises a shroud spaced radially outward from the conduit portion to define a gap therebetween, with the shroud being disposed about the longitudinal axis for surrounding the conduit portion.

4. The paint spray nozzle of claim 3, wherein the second surface comprises a frustoconical surface with a diameter that linearly increases from the inlet cross-sectional width to the outlet cross-sectional width.

5. The paint spray nozzle of claim 4, wherein the first passage comprises first and second ends along the longitudinal axis with the second end positioned downstream of the first end, and the conduit portion includes a cylindrical surface having a constant inner diameter along the longitudinal axis from the first end to the second end.

6. The paint spray nozzle of claim 5, wherein the frustoconical surface and the cylindrical surface are positioned coaxially relative to one another.

7. The paint spray nozzle of claim 6, wherein the frustoconical surface is disposed 60 degrees relative to the frustoconical surface.

8. The paint spray nozzle of claim 7, wherein the first and second surfaces face the longitudinal axis.

9. A paint spray system comprising:
a reservoir of paint;
a paint spray nozzle comprising a single-piece body, the single-piece body having a conduit portion that includes:
a first surface defining a first passage that terminates at an orifice along a longitudinal axis; and
a second surface that defines a second passage along the longitudinal axis, with the second passage fluidly connected to the orifice;
wherein the orifice is configured to direct the paint to flow along a flow path through the second passage;
wherein the second surface defines an inlet cross-sectional width positioned at the orifice and an outlet cross-sectional width positioned at an outlet, with the inlet and the outlet being spaced from one another along the longitudinal axis, and the outlet cross-sectional width being larger than the inlet cross-sectional width, such that the paint that deposits on the second surface is positioned relative to the longitudinal axis to be re-absorbed into the flow path of the paint; and
wherein at least a portion of the second surface comprises a paint repellant material; and
a pump for pumping paint from the reservoir to the paint spray nozzle.

10. The paint spray system of claim 9, wherein the paint repellant material comprises one of a hydrophobic material and a hydrophilic material.

11. The paint spray system of claim 10, wherein the paint repellant material comprises a coating bonded to the second surface.

12. The paint spray system of claim 11, wherein the coating comprises at least one of a polyurethane, a nano-particle, and a fluorinated hydrocarbon.

13. The paint spray system of claim 11, wherein the second surface includes an inlet surface portion adjacent to the orifice and an outlet surface portion adjacent to the outlet, and the coating covers an entirety of the inlet surface portion.

14. The paint spray system of claim 13, wherein the outlet surface portion is free of the coating.

15. The paint spray system of claim 13, wherein the second surface includes a plurality of capillary grooves spaced radially from one another about the longitudinal axis for drawing paint toward the orifice and a flow of paint therethrough.

16. The paint spray system of claim 13, wherein the conduit portion terminates along the longitudinal axis at the outlet.

17. The paint spray system of claim 16, wherein the single-piece body further comprises a shroud spaced radially outward from the conduit portion to define a gap therebetween, with the shroud being disposed about the longitudinal axis for surrounding the conduit portion.

18. The paint spray system of claim 17, wherein the second surface comprises a frustoconical surface with a diameter that linearly increases from the inlet cross-sectional width to the outlet cross-sectional width.

19. A method of operating a paint spray nozzle, with the paint spray nozzle including a single-piece body having a conduit portion, with the conduit portion including a first surface defining a first passage that terminates at an orifice along a longitudinal axis and a second surface that defines a second passage along the longitudinal axis, with the second passage fluidly connected to the orifice, the second surface defines an inlet cross-sectional width positioned at the orifice and an outlet cross-sectional width positioned at an outlet, with the inlet and the outlet being spaced from one another along the longitudinal axis, and the outlet cross-sectional width being larger than the inlet cross-sectional width, the method comprising:
directing, using the orifice, the paint to flow along a flow path through the second passage; and
positioning, using the second surface, paint deposited on the second surface relative to the longitudinal axis such that the paint is re-absorbed into the flow path of the paint.

20. The method of claim 19, further comprising:
directing, using the orifice, a cleaning solvent to flow along the flow path through the second passage; and
positioning, using the second surface, paint deposited on the second surface relative to the longitudinal axis such that the cleaning solvent removes paint from the second surface.
